(19) United States
(12) Patent Application Publication
(10) Pub. No.: US 2009/0305185 A1
(43) Pub. Date: Dec. 10, 2009

(54) Method Of Designing Custom Articulator Inserts Using Four-Dimensional Data

(76) Inventor: Mark D. Lauren, Amherst, NY (US)

Correspondence Address: HODGSON RUSS LLP;THE GUARANTY BUILDING, 140 PEARL STREET, SUITE 100, BUFFALO, NY, 14202-4040, US

(21) Appl. No.: 12/435,940

(22) Filed: May 5, 2009

Related U.S. Application Data
(60) Provisional application No. 61/126,355, filed on May 5, 2008.
(60) Provisional application No. 61/211,941, filed on Apr. 6, 2009.

(51) Int. Cl. A61C 11/00; A61C 19/04; G06F 17/50

(52) U.S. Cl. 433/29; 433/54; 433/215; 703/1; 700/98; 700/159; 700/119; 700/197

(57) ABSTRACT

The present invention provides methods for designing dental articulator inserts from 3d dental data (4d datasets). These 4d datasets may be used directly to provide a jaw motion model suitable for enhanced CAD or, they may be used to derive mathematical expressions that are then used to design dental articulator inserts. The methods of the invention are based on acquiring time-based 3d data representing the upper and lower teeth. Each datum in the 4d dataset may therefore contain an accurate record of the relationship between the upper and lower arch in three dimensions.

### CROSS-REFERENCE TO RELATED APPLICATION

This application claims the benefit of priority to U.S. provisional patent application Ser. No. 61/126,355, filed on May 5, 2008, now pending, and U.S. provisional patent application Ser. No. 61/211,941, filed on Apr. 6, 2009, now pending, both of which disclosures are incorporated herein by reference.

### FIELD OF THE INVENTION

The present invention relates to dental devices and processes providing improved and more accurate means for recording jaw movement and reproducing the jaw movement in a dental articulator.

### BACKGROUND OF THE INVENTION

Mechanical articulators have been used to model jaw motion for over 200 years, with the Gariot model being the first to come into standard use around 1805. Modern articulators are essentially accurately machined versions of the Gariot design, with the addition of adjustable mechanical features to more closely model a person's condyle motion.

The main shortcoming of dental articulators, generally, is their inability to accurately model a person's true jaw motion. This was recognized as early as the 1890's by Walker who was the first to record the true path of a person's condyle using a pencil lead and a sheet of stiff paper. Walker also constructed an articulator capable of reproducing the recorded movements. Since that time, many attempts have been made to customize dental articulators to more closely duplicate the actual jaw motion of an individual.

Dental casts are mounted to articulators to provide a simulation of hinge rotation and border movements. The current practice for mounting dental casts to articulators involves taking a facebow record. A facebow record is obtained by using a jig to record a single position of the maxillary arch with respect to a subjectively determined anatomic hinge axis. The frame or jig is then removed from the person and attached to an articulator to transfer the position of the maxillary cast with respect to the hinge axis of the articulator. The position of the maxillary case is thereby fixed with respect to the articulator and the hinge axis of the articulator. However, even with a perfect facebow transfer (from person to articulator), the articulator still cannot duplicate the person's jaw motion, since the motion is determined by the geometry of the articulator and not the person. Since adjustable articulators are currently used in dental laboratories to fabricate state-of-the-art oral appliances and prosthetics, their limitations have become accepted practice.

Currently, dental articulators may be customized to more closely reproduce a person's jaw motion in two ways:

1) Clinical jaw tracking data may be used to record the path of the condyle of a person and pre-made mechanical inserts may be selected or adjustable features on an articulator system may be set to more closely model a person's jaw motion. Some articulators (e.g. the SAM articulator from Great Lakes Orthodontics, Tonawanda, N.Y.) offer a sets of plastic inserts to provide different condylar eminence ramps or Bennet angle paths. Adjustable parameters may include setting a fixed Bennet or condylar inclination angle. Significant effort is required to set up and align frame systems required to capture the clinical jaw tracking data. The captured motion is then used to set an articulator parameter which itself is an approximation. Such clinical procedures are therefore rarely performed in practice. An example is provided by Stuart (U.S. Pat. No. 2,814,876).

2) A physical 3-dimensional (3d) record or analog of condyle motion may be produced and attached to an articulator to provide person-specific 3d motion. Typically, the physical record is made using a double frame system, wherein one frame is attached to the skull and a second independent frame attached to the lower jaw. A scribe attached to one frame element is used to carve-out or sculpt a formable material held by the second frame element. In this manner, a control surface is formed. When attached to an articulator, the control surface allows a stylus-type element on the articulator to serve as a mechanical follower, thereby transferring the clinically captured motion to the articulator. Such customized analogs provide a more accurate representation of a person's jaw motion than interchangeable mechanical elements or settings. Examples of such direct physical methods for producing such custom analogs are as follows:

Musante (U.S. Pat. No. 1,670,311) utilizes a set of cups filled with wax and a corresponding set of scribes to sculpt a set of patterns in the wax to reflect a person's jaw motion. This physical recording is then transferred to a custom articulator.

Reith (U.S. Pat. No. 2,043,394) provides a method for reproducing jaw movements by abrading the surface of a plastic material. These plastic plates are then used to reproduce a person's jaw movement for fabricating dentures.

Shanahan (U.S. Pat. No. 2,220,734), Kile (U.S. Pat. No. 2,418,648), and Highkin (U.S. Pat. No. 2,754,589) use a recording pin and three flat containers filled with a soft moldable material.

Irish (U.S. Pat. No. 3,423,834) uses styli to carve the surface of three cups filled with cold cure acrylic to record mandibular movements. The frame assembly with the cups is then transferred to an articulator to provide customized motion.

Weisberg (U.S. Pat. No. 3,321,832), Lee (U.S. Pat. No. 3,452,439), and Weisbery (U.S. Pat. No. 3,321,832) describe two frame-mounted air-driven drills that mill the surface of a hard plastic as a persons moves their jaw. The milled surfaces are then integrated into an articulator to provide customized motion.

Knap (U.S. Pat. No. 4,681,539) describes a frame system which uses a stylus directly driven by jaw motion to carve-away a soft recording medium contained in a cavity. The cavity is then removed and attached to an articulator to provide the patient-specific motion.

Roup (U.S. Pat. No. 4,368,041) provides a double frame system with self-polymerizing plastic in receptacles attached to the maxillary frame.

In spite of their ability to provide patient-specific motion to articulators, none of the above methods have found routine clinical use due to practical limitations. Most require the use of a clutch, or mouthpiece, to connect the lower frame element to the jaw. Clutches must be customized to the individual, which is time-consuming. Clutches also prevent a person from fully closing his mouth. The prior methods also require fitting and aligning mechanical frames to a person using springs, rubber bands, or magnets to press a stylus against the recording medium. The use of moldable or chemically setting materials can be messy and require timely procedures.

Methods are also known for acquiring 3d jaw position data that may be suitable for designing custom condylar analogs or inserts for articulators. There are, for example, electronic, ultrasonic, magnetic, electromagnetic, and optically-based systems.

Examples of 3d optical jaw tracking methods include: Kataoka (U.S. Pat. No. 4,447,207) showing frame-mounted LEDs; Klett (U.S. Pat. No. 4,495,952) using light transmitters secured to the jaw; Neumeyer (U.S. Pat. No. 4,859,181) using measuring elements attached to the upper and lower teeth; Baumrind (U.S. Pat. No. 4,836,778) using frame-mounted Infrared LEDs; Duret (U.S. Pat. No. 5,143,086) using a frame system with three LEDs fixed to the teeth; Summer (U.S. Pat. No. 5,989,023) showing a custom intra-oral device with an LED and a sensing pad; and Kim (U.S. Pat. No. 7,182,737) using markers on left side & right side of patient's face and an intra-oral attachment.

These methods also suffer from the same frame-related limitations previously described. Current art still requires the use of either independent frames or optical targets on the mandible and maxilla to acquire 3d jaw motion data. In addition, a custom clutch is generally required to be inserted into a person's mouth. These methods have limited accuracy due to frame alignment errors and minor movement of the frames. The presence of the frames themselves can also affect natural jaw function. There remains no convenient means for acquiring condylar path clinical data, nor any convenient means for utilizing these data to customize a dental articulator. This is reflected in the fact that none of the aforementioned methods, in spite of their potential benefits, have found significant commercial use.

Time is often considered the fourth dimension in physics. Time-based changes in 3d systems constitute a 4-dimensional (4d) system. The acquisition of time-based 3d data is also referred to as 4d scanning. Four-dimensional methods have been used to study jaw dynamics by optical tracking the 3d position of targets located on frames attached to the maxilla and mandible over time. These methods all remain somewhat cumbersome and technically complex.

An object of the invention to provide a convenient, accurate, and rapid method for acquiring 3d jaw motion data from a person and transferring these data to an articulator to provide customized articulator motion that more accurately simulates the person's jaw motion.

Another object of the invention is to provide a digital method for determining condyle motion, and then to produce a physical analog of condylar motion to be inserted into an articulator to provide customized motion. Digital design is amenable to the calculation of a smooth condylar analog surface, which is not possible using a mechanical stylus system. Digital methods also allow for more natural jaw motion during scanning by not requiring cumbersome attachments.

The present invention provides digital methods for obtaining and utilizing jaw motion data from a person to customize dental articulators for the enhanced design and manufacture of oral appliances and prosthetics.

### BRIEF SUMMARY OF THE INVENTION

The present invention provides digital methods for obtaining and utilizing jaw motion data from a person to customize dental articulators for the enhanced design and manufacture of oral appliances and prosthetics.

The methods of the present invention are based on using an imaging device to acquire 3d images or frames that represent the upper and lower teeth in various jaw positions. The 3d images may be a set of time-based 3d images (or 4d sequence), with each 3d frame in the time sequence capturing some upper and lower arch anatomy (the oral anatomy). Each image in the 4d sequence therefore contains an accurate record of the relationship between the upper and lower arch in three dimensions. While the individual scans may not capture the complete dentition, the amount of data captured should be sufficient to allow overlapping 3d surface data of the dentition to be registered to these data to provide a more complete representation of the arches.

Since both the head and the camera may move independently of each other during scanning, the raw 4d scans captured by the imaging device are considered “floating” as there is no fixed reference except for the world coordinates of the imaging device. A single 3d image may be taken and used as a reference frame, defining the fixed position of the upper and lower arches for determining the relative position of the two jaws.

The invention may be embodied as a method for designing a condylar insert for a dental articulator. A set of 3d images that represents the oral anatomy of a person during jaw motion may be obtained and a hinge axis location computed with respect to the upper or lower arch data. Left- and right-side condylar marker points may be defined on the hinge axis and the position of the two condylar marker points may be tracked to determine a locus of positions of each marker point. The locus of positions may be used to design a surface of each of two articulator inserts. The inserts may be manufactured and used with a dental articulator to substantially mimic the motion of the person's jaw. The invention may also be embodied as dental articulator inserts designed by the above method.

In another embodiment of the invention 4d clinical jaw position data is used to determine the locus of 3d positions of an individual's left and right-side condyle. This may be done by first defining the location of a theoretical hinge axis with respect to the lower arch by fitting a circular arc to short-range open/close 4d scan data. The position of two virtual marker points on the theoretical hinge may be defined, equidistant from the arch midline and separated by the intercondylar distance of a dental articulator. The position of these two market points is followed as the lower arch moves. A surface is rendered through the locus of 3d condylar center positions to produce a theoretical articular surface. This surface represents the locus of positions assumed by the center of a condylar ball of an articulator and is equivalent to a condylar analog.

In another embodiment of the invention the condylar position data are used to design a custom insert to be placed in a dental articulator to provide patient-specific motion to the mechanical device. Inserts may be designed to fit specific articulator systems and produced using modem milling or rapid prototyping methods.

The custom condylar insert provides the means to improve the quality of oral appliances and prosthetics designed using dental articulators by providing patient-specific motion to the device.

### DESCRIPTION OF THE DRAWINGS

For a fuller understanding of the nature and objects of the invention, reference should be made to the following detailed description taken in conjunction with the accompanying drawings, in which:

FIG. 1 is a perspective view of an example of a prior art articulator;

FIG. 2 is a perspective view of an extra-oral camera system;

FIG. 3 depicts an example 3d image frame from a 4d sequence according to one embodiment of the invention which may also be used as a reference frame or scan;

FIG. 4 is a flow chart of a method according to the invention;

FIG. 5 depicts a mandibular model and a hinge axis used to determine the arch midline;

FIG. 6 is a mid-saggital view through a right condylar ball of an articulator;

FIG. 7 is a perspective view of the right-side condylar ball of FIG. 6, showing the location of the initial contact point and the anterior ramp; and

FIG. 8 is a mid-coronal view of the right condylar ball of FIGS. 6 and 7.

### DETAILED DESCRIPTION OF THE INVENTION

4d Data Capture

A dataset that contains the instantaneous 3d relative position of the mandible of a person with respect to the skull may be captured by imaging or scanning a portion of the facial or buccal aspects of the upper and lower teeth and mucosa. The data used to render the 3d surface in the captured image may be obtained using laser or structured light, or photogrammetry targets. The dataset may be captured using a digitizer which may be an optical imaging device, capable of acquiring at least 1 image frame per second in three dimensions. A set of 3d images may be captured by such a digitizer; the set may be a time-based series of 3d images-known as a 4d sequence. Each 3d image in the time-based series may contain a digital record of the relationship between the upper and lower arches in three dimensions. The 3d image(s) may be obtained through intra-oral or extra-oral scanning.

Extra-oral scanning of the facial/buccal aspect of the oral anatomy may capture more data in orthogonal directions than the intra-oral method. A suitable imaging device to perform a method according to the present invention may consist of a hand-held structured light or laser scanner that may primarily capture the facial and buccal aspect of a person's oral anatomy. The oral anatomy may include portions of the upper and lower teeth and soft tissues.

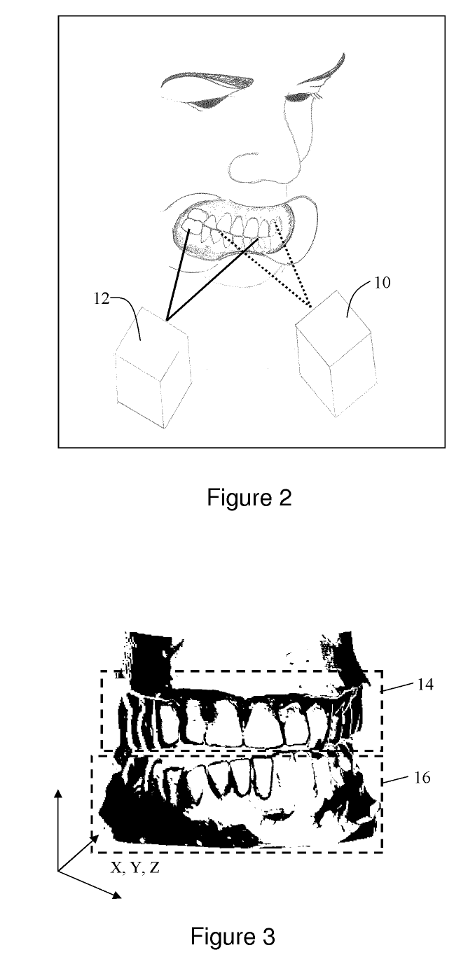

FIG. 2 shows an example of the positioning of an imaging device 10. The imaging device 10 can be positioned using light guides that may be projected from the imaging device 10 onto a person's face. These guides ensure that the imaging device 10 is correctly positioned at the proper distance for the depth of field as well as the desired horizontal and vertical fields of view. The imaging device 10 may be located at a distance from the patient's mouth to allow the dentition to be imaged from, for example, the bicuspid 11 on the left side of the figure to the bicuspid 11 on the right side of the figure.

The imaging device 10 may be positioned at a location 13 directly in front of the mouth, or at an angle at lateral positions, for example at position 12, to capture more distal anatomy. This arrangement may capture data over a greater x, y, and z range than a frontal scan, which is advantageous for the accurate registration of more complete models because it may provide more data in three orthogonal directions.

Vertically, the full open jaw position represents the maximum distance required to be imaged. The imaging device 10 may typically capture a portion of the upper and lower arches. Any device capable of acquiring equivalent 3d data is suitable for the execution of the inventive method.

Structured light or stereo image pair systems may be suitable for 3d image capture. The short acquisition time of these systems may reduce imaging distortion due to the relative motion between the camera and the person's mouth, as well as relative motion between the upper and lower arches.

The teeth within the camera's field of view may be coated with a material such as titanium dioxide to provide a clean surface reflection for the imaging device. The coating material may also assist with differentiating the upper and the lower arch. Colored, white, or other reflective materials or targets can be used to both assist with imaging as well as differentiating upper and lower arch anatomy. Commonly used intra-oral whitening sprays using titanium dioxide are suitable.

In an alternate embodiment, small targets may be placed on the upper or lower teeth to serve as photogrammetry targets for a 3d imaging system. Beads may be, for example, 5-150 micron diameter polystyrene. Beads may be applied to the oral anatomy as small patches, for example, the patches may be approximately 20 square mm. A patch may contain, for example, about 500 beads per square mm. The location of each bead in a patch may provide target point locations, which may be used to define a 3d surface for the patch. The markers, or beads, may be fluorescent, colored, or otherwise made to be visible to the imaging system. Since the bead patches are on the teeth, more complete oral anatomy may be registered to the patches in a reference frame to allow position related geometry or marker points to be tracked according to the 4d data.

Clinical 4d scanning involves instructing an individual to move his jaw in a prescribed fashion while the imaging unit captures a time-based sequence of 3d images of the oral anatomy. Jaw motions useful for the example applications of this invention may include, but are not limited to: 1) initial opening and closing of the mouth and a centric relation reference scan, 2) protrusion for determining angle α lateral border movements for determining left and right-side angles β, and 3) random motions to capture the envelope of motion. Although time-based 3d images are described, it should be noted that the images need not be time-based and may be a set of 3d images of the jaw in positions which represent the range of motion of the jaw.

4d Models and Reference Frames

The time-based 3d images may be used to develop useful 4d models for simulating jaw motion. Two basic methods are described, with equivalent results possible using alternate means: 1) “registration-based method” —a frame-by-frame registration of the 4d images to a reference frame, and 2) “degree of freedom method” —a mathematically-based method for describing the incremental change in position of the lower arch using degree-of-freedom (“Dof”) expressions.

For both 4d modeling methods, a single image may be defined as a reference frame. The reference frame may be used to define the fixed location of the upper arch and a starting or zero position for the lower arch. The reference frame may be a single captured image or an image that is part of a 4d sequence. In a preferred embodiment, contiguous upper or lower arch surface anatomy may be registered to the reference frame to expand the upper and lower arch surfaces of the reference frame. This may be performed to ensure sufficient surface area for the registration of other frames in a 4d sequence.

Referring to the registration-based method, the reference image or frame may be used to define the fixed position of the upper arch and a starting, or “zero,” position of the lower arch. The upper arch surface data in a second frame may then be registered to the upper anatomy of the reference. Since the upper arch data for the second frame now coincides with the reference position, the difference in position of the lower arch data between the reference frame and the second frame represents the true jaw position of the second frame. This process may be repeated for each frame in a sequence producing a set of 3d images that represents a model of jaw motion.

Referring now to the degree of freedom method, six degree of freedom (“6Dof”) expressions are coordinate transforms used to relate two coordinate systems to each another within the same space. Such transformations consist of functions that define both rotations and translations. The degree of freedom method computes a set of mathematical expressions that represents the incremental change in position of the lower arch. A 6Dof expression is computed for each frame, and a set of 6Dof expressions corresponding to a sequence of frames forms the mathematical basis for the jaw motion simulation model.

FIG. 3 depicts an example 3d image frame which may also be used as a reference frame or scan. The upper data set 14 and lower data set 16, serve as reference positions for registration-based as well as 6Dof-based 4d models.

Reference frames may also be used for a 6Dof method by defining the fixed location of the upper arch and a starting or zero position of the lower arch. The following sequence is provided as a non-limiting example only. An equivalent result may be obtained using a different progression along similar technical lines.

After registering the upper anatomy of frame n to a reference frame, the position of the lower arch position data in frame n is mathematically compared to the lower arch position in the reference frame. A 6Dof transform is computed that moves the lower arch data from its reference position to its position in frame n. The transform for frame n is a mathematical expression that, when applied to the lower arch data set of a reference frame, results in the position of the lower arch data set in frame n. Continuing this process for each frame in a set of 3d images produces a set of 6Dof expressions that describes the jaw motion for the particular set of 3d images.

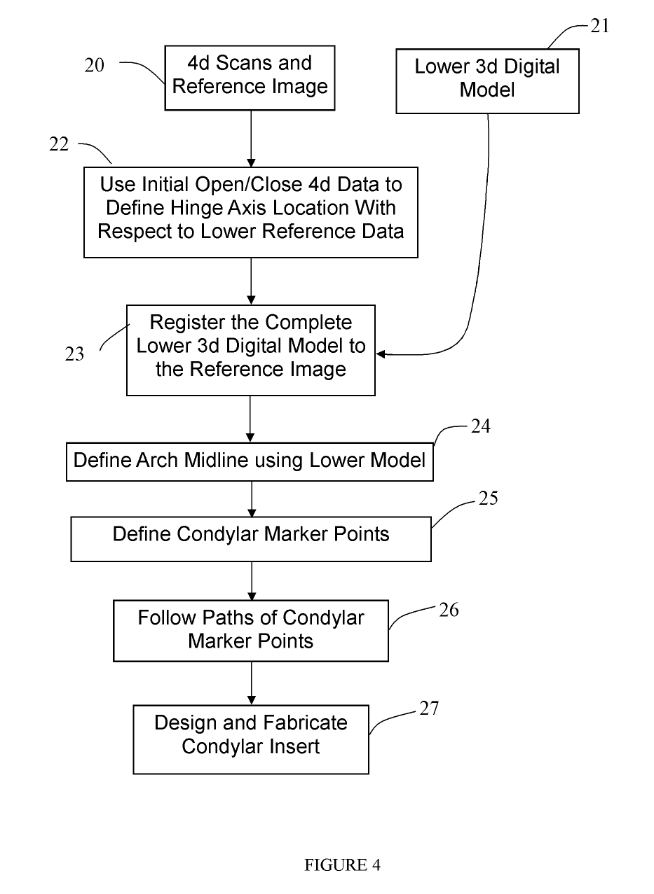

FIG. 4 diagrams a flow chart of the method according to an embodiment of the invention. Patient 4d scan data are collected 21 which may include a reference frame, initial open/close data, border movements, and/or random movements. A complete lower 3d model 20 is obtained either by scanning casts made from an oral impression or from intraoral scanning. The location of a hinge axis with respect to the lower arch data in the reference frame is determined by fitting an arc to the initial open/close 4d data 22. The lower 3d model is registered to the lower surface data in the reference image, 23. The lower 3d model is used to define an arch midline 24 which intersects the hinge axis midway between the condylar balls of an articulator. Two virtual marker points 25, corresponding to the center positions of the condylar balls of a particular articulator are defined on the hinge axis equidistant from the midline. The position of these left and right-side marker points is followed, using the 4d scans, to produce the locus of condylar center positions 26. A surface is rendered using the locus of condylar positions to design the condylar insert 27.

Articulator Model

The particular articulator to be used with the physical model may be modeled in the virtual space of a computer system. This may be done by dimensioning the geometry of the system and creating a model representing the articulator system geometry in software.

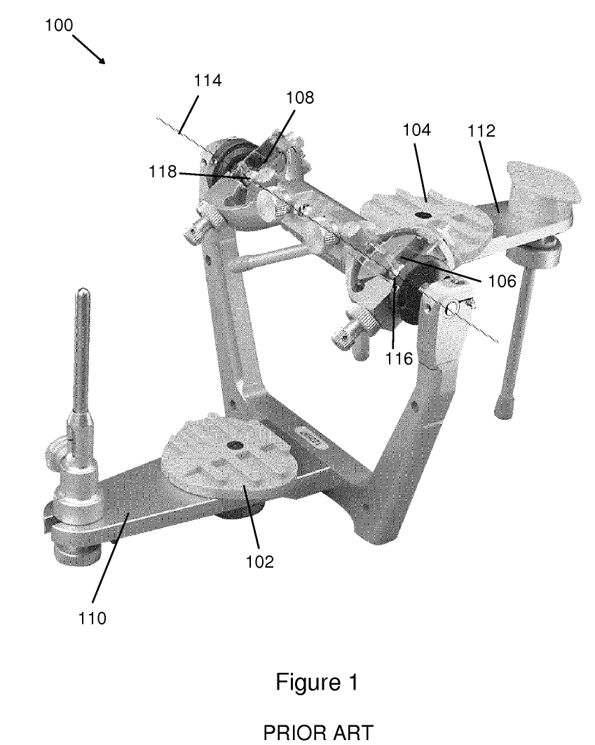

A representative articulator 100 is shown in FIG. 1. Generally, an articulator 100 may comprise an upper frame 112 and an lower frame 110. An upper and a lower dental cast may be mounted to an upper mounting plate 104 and a lower mounting plate 102 respectively. The upper frame 112 may rotate with respect to the lower frame 110 about a hinge axis 114 defined by a left condylar ball 116 and a right condylar ball 118. The upper frame 112 may be allowed to translate with respect to the lower frame 110. The range of such translational movement is dictated by the shape of a left condylar insert 106 and a right condylar insert 108 having surfaces on which the left and right condylar balls 116, 118 may move. An articulator may model the geometry of a particular person's temporomandibular joint by providing left and right condylar inserts 106, 108 that represent the motion of that person's condyle.

Determination of Condylar Center Positions

Since the mandible provides a rigid connection between the lower dentition and the condyles, it is possible to use 4d data to track the path of two points-marker points-mathematically related to the lower arch, which represent the centers of the left- and right-side condylar balls 116, 118 of a modeled articulator. In an embodiment of the invention, two such marker points, defined on a theoretical hinge axis, are followed to derive a locus of 3d positions of the left- and right-side condylar centers. From these data, a custom condylar insert 106, 108 for an articulator may be designed and produced. FIG. 4 shows a flowchart of a method according to an embodiment of the invention comprising the following steps:

a) A lower 3d digital models of the person's dentition, 21, may be obtained using known methods, such as scanning stone models made from oral impressions, or intraoral scanning.

b) The location of a theoretical hinge axis may be determined with respect to the lower data in the reference frame by fitting a circular arc to scan data taken during the initial opening and closing motion of the jaw. When computing the hinge axis location, the upper data in the reference frame may be considered fixed, and the hinge location may be initially defined with respect to the fixed upper data. Once the hinge axis is fixed with respect to the upper arch, the location of the hinge may then be defined with respect to the lower arch by using a reference image taken in centric relation or a closed position.

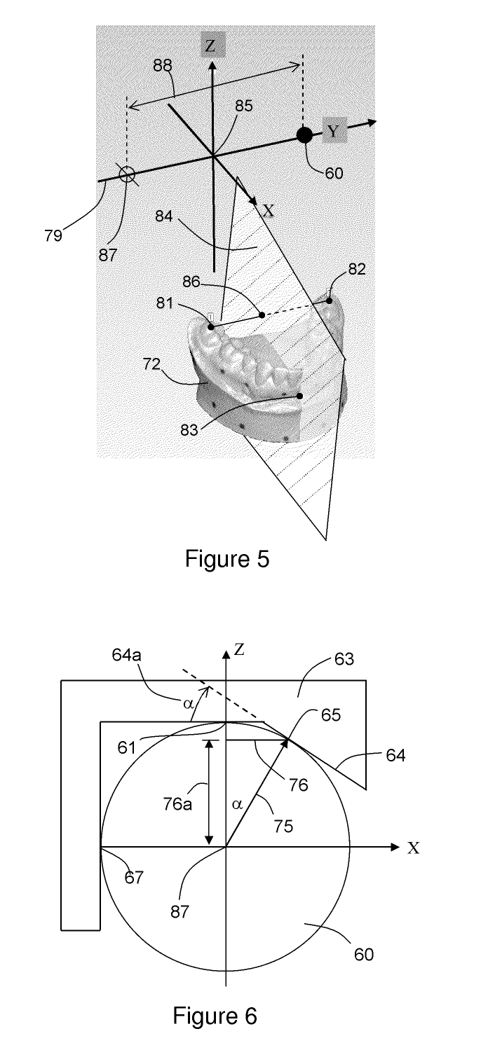

c) The complete lower 3d model is then registered to the surface data of the reference image. An arch midline is then virtually defined. FIG. 5 illustrates the elements involved with determining an arch midline using a mandibular model 72 (in this non-limiting example, a plaster cast). Points 81 and 82 may be manually located by a software user equidistant from a visual arch midline. A perpendicular plane 84 may be constructed through the midpoint 86 of points 81 and 82. Plane 84 passes though the hinge axis at the midpoint 85 between the virtually positioned condylar balls 60 of the articulator. Plane 84 becomes the XZ plane of a coordinate system with its origin at the midpoint 85 of the theoretical hinge axis. Condylar balls 60 may be located equidistant from midpoint 85 on the theoretical hinge axis 79. Alternatively, the plane may be forced to pass through midpoint 86 and an optional point defined on the anterior anatomy 83. Two condylar marker points 87 on the theoretical hinge axis 79, equidistant from the axis midpoint and separated by an intercondylar distance 88, are shown. The marker points may be modeled to be at the center of the condylar balls of a particular articulator. Separate left and right-side marker point coordinate systems may be located to serve as a reference for defining the position of condylar movement. For the right side marker point, positive Y is medial, while the left marker has −Y as measuring medial position. The intercondylar distance 88 is 110 mm for the SAM articulator system. Two marker points 87 may be defined on the theoretical hinge axis 79 corresponding to the location of the centers of the left and right condylar balls for a particular articulator system.

d) The locus of positions determined for the marker points may be converted to a surface using software tools well known in the art. This surface reflects the 3d paths for the center of the condylar balls of an articulator needed to duplicate the scanned jaw motion.

Design of Custom Condylar Inserts

The surface produced from the locus of marker point positions reflects the movement of the center of the condylar balls. This surface may be designed as part of an insert to be placed in an articulator such that when the condylar balls of the articulator ride on the surface of the insert, the center of the balls reflects the computed surface. The insert must be designed so that when attached to the articulator, the center of the condylar balls followings an identical path to the computed 3d condylar motion. After determining the desired 3d condylar motion, insert design involves determining the initial contact points of the insert with the condylar ball, and designing the insert to fit a specific articulator.

As soon as a condylar ball begins to move forward or laterally, it rides on the surface of the insert. The insert presents two distinct contact surfaces to the condylar ball: 1) a surface for anterior and lateral movement, and 2) a surface to limit lateral border movement.

FIG. 6 is a mid-saggital view through the right condylar ball, 60 of an articulator. With the condylar ball 60 in the fully seated position, the upper moveable element of the articulator 63 contacts the condylar ball 60 in three locations: 1) distally at point 67, superiorly at point 61, and anteriorly at point 65. A constant condylar inclination angle α, 64 a is shown as straight line 64. For the SAM articulator system (Great Lakes Orthodontics, Tonawanda, N.Y.), the condylar balls 60 are 10.0 mm in diameter; radius 75 is therefore 5 mm. Lengths 76 and 76a are computed from angle α and radius 75. These values are used to locate the initial contact point of the condylar ball and the insert. The location of point, 65, is computed as follows for the SAM articulator system with a 10 mm diameter condylar ball 60: the radius 75 is 5 mm; the x component of point 65 is 76, computed as 5 sin α; the z component, 76a, is computed as 5 cos α; and the y component is zero.

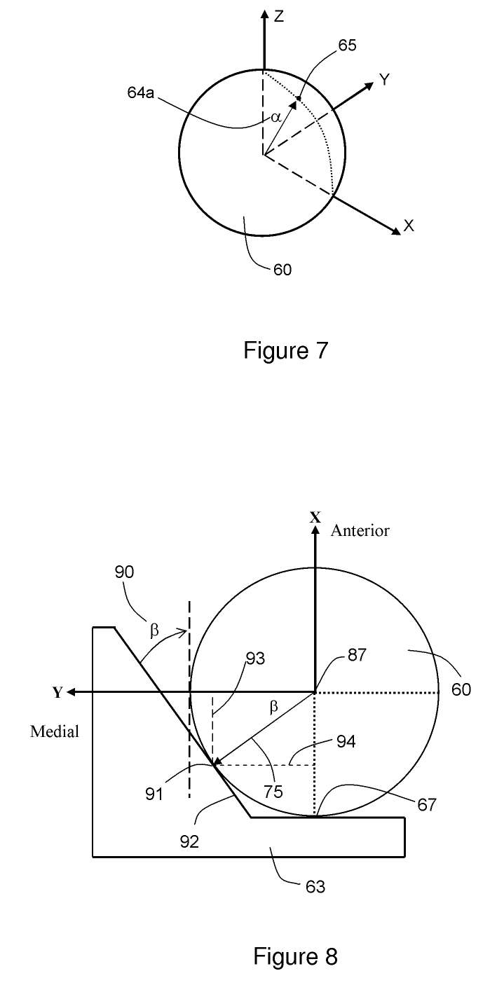

FIG. 7 is a perspective view of a right-side condylar ball 60 showing the location of the initial contact point with the anterior ramp 65. Contact takes place at point 65 on the condylar ball 60 surface, which is in the xz plane located α degrees from the z axis. Angle α, 64a, is the condylar inclination angle defined in the x direction for initial protrusive movement obtained by 3d scanning in protrusion. Clinically, this may be captured by scanning protrusive motion starting from the fully closed, centric occlusion, centric relation position, or other reference position.

FIG. 8 is a mid-coronal view of the right condylar ball of an articulator. A constant medial Bennet angle β, 90, is shown, which defines the maximum allowed medial movement of the condylar ball of the articulator. In the fully seated position, the condylar ball touches the surface that provides medial guidance at point 91. A surface 92 perpendicular to the XY plane provides a limiting boundary for medial movement of the condylar balls. Lengths 93 and 94, used to locate contact point 91, may be computed from angle β and radius 75.

As shown in FIG. 8, the insert contacts the condylar ball 60 at point 91, calculated from angle β. Angle β is determined by analyzing marker point movement during initial lateral jaw movement. Individual left and right-side values are determined. Clinically, these data are obtained by scanning a person while they move their jaw laterally from the fully closed, centric occlusion, centric relation, or other reference position. These data are used to locate the initial contact point of condylar wall on the condylar ball 60, point 91. Once β is determined from lateral jaw excursion data, the location of point 91 may be determined geometrically with a known condylar ball 60 diameter.

Line 92 presents a limiting medial surface to the condylar ball 60 motion. The shape of this border line movement is obtained by 3d scanning during limiting lateral border movement. The condylar ball 60 slides along a vertical surface that is perpendicular to the xy plane as the condylar ball 60 moves laterally. Insert design includes converting the limiting lateral border movement into a vertical wall to limit the lateral movement of the condylar balls 60.

Condylar inserts 106, 108 may be produced using rapid prototyping or conventional milling means. For milling, a readily machinable metal such as brass or a hard plastic may be suitable. The condylar insert 106, 108 can start as a pre-shaped blank to aid with fitting to a specific articulator.

In another embodiment according to the invention, dental articulator inserts 106, 108 may be designed and/or manufactured by any of the above-described methods.

Although the present invention has been described with respect to one or more particular embodiments, it will be understood that other embodiments of the present invention may be made without departing from the spirit and scope of the present invention. While the SAM articulator is used as an example herein, it should be recognized that the invention is not limited to this particular articulator. Hence, the present invention is deemed limited only by the appended claims and the reasonable interpretation thereof.

What is claimed is:

1. A method for designing inserts for a dental articulator, comprising the steps of:
obtaining a set of 3-dimensional data representing at least two positions of the oral anatomy of a person during jaw motion;
computing a hinge axis from the set of 3-dimensional data;
defining two condylar marker points on the hinge axis;
determining the position of the two condylar marker points in each of the at least two positions of the oral anatomy in the set of 3-dimensional data to determine a locus of positions of each condylar marker point;
using the locus of positions to design a surface of each of two inserts, corresponding to each of the two condylar marker points, for a dental articulator.

2. The method of claim 1 further comprising the step of manufacturing the two inserts.

3. The method of claim 2 wherein the inserts are manufactured by milling, rapid prototyping, or molding.

4. The method of claim 1 wherein the set of 3-dimensional data comprises a set of 3-dimensional target point locations.

5. The method of claim 1 wherein the set of 3-dimensional data comprises a set of 3-dimensional images.

6. The method of claim 5 wherein the set of 3-dimensional images is time-based.

7. The method of claim 6 wherein the set of time-based 3-dimensional images comprises at least two three-dimensional images of the oral anatomy, wherein the at least two images are captured at different times during jaw motion.

8. The method of claim 1 wherein the set of 3-dimensional data is obtained by intra-oral scanning.

9. The method of claim 1 wherein the set of 3-dimensional data is obtained by extra-oral scanning.

10. The method of claim 1 wherein the set of 3-dimensional data is obtained by photogrammetry.

11. An insert for a dental articulator designed by a process comprising the steps of:
obtaining a set of 3-dimensional data representing at least two positions of the oral anatomy of a person during jaw motion;
computing a hinge axis from the set of 3-dimensional data;
defining two condylar marker points on the hinge axis;
determining the position of the two condylar marker points in each of the at least two positions of the oral anatomy in the set of 3-dimensional data to determine a locus of positions of each condylar marker point;
using the locus of positions to design a surface of an insert for a dental articulator.
